(19) United States
(12) Patent Application Publication
(10) Pub. No.: US 2017/0364990 A1
(43) Pub. Date: Dec. 21, 2017

(54) PERSONALIZED TICKET EXCHANGE

(71) Applicant: eBay Inc., San Jose, CA (US)

(72) Inventor: Girish Vasvani, Fremont, CA (US)

(21) Appl. No.: 15/185,883

(22) Filed: Jun. 17, 2016

(51) Int. Cl. G06Q 30/06; G06Q 30/02

(52) U.S. Cl. CPC G06Q 30/0631; G06Q 30/0201

(57) ABSTRACT

Embodiments of the present disclosure are related to electronic commerce. A method may include identifying a user of an online marketplace. The method may also include accessing data associated with the user including at least one of historical data, location data, and user defined data. Further, the method may include providing the user with at least one ticket option including at least one recommended ticket for at least one event based on the data associated with the user.

### FIELD

The present disclosure relates generally to electronic commerce. More specifically, the present disclosure includes embodiments related to personalized ticket exchange in an online marketplace.

### BACKGROUND

Some online web services enable exchange of tickets for events. The tickets may be used to reserve seats and/or admission for the events, such as sporting events, concerts, theater events, parking at such events, and other entertainment events. Using an online web service, a user may search for available tickets and decide which, if any, of available tickets are of interest based on information provided by the online web service.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

Example embodiments will be described and explained with additional specificity and detail through the use of the accompanying drawings in which:

FIG. 1 illustrates an example system in which some embodiments may be implemented;

FIG. 2 is a flowchart depicting a method, in accordance with an embodiment of the present disclosure;

FIG. 3 is a flowchart depicting another method, in accordance with an embodiment of the present disclosure; and

FIG. 4 illustrates an example computing system configured for implementation of a marketplace interaction.

### DETAILED DESCRIPTION

In an online marketplace, “best value” tickets, which may have the greatest discounts and/or lowest prices, may be identified. However, this approach may cause competition among industry players resulting in razor thin margins.

Various embodiments of the present disclosure are related to online ticket marketplaces and, more specifically to identifying event tickets that may not necessarily be the “lowest priced” or “most discounted,” but rather tickets that may be the “best match” for a user. According to one embodiment, a system may include at least one processing element configured to identify a user of an online marketplace. The at least one processing element may further be configured to determine at least one ticket option including at least one potential ticket for at least one event based on user data associated with the user. The user data may include historical data for the user, location data for the user, or data defined by the user. Moreover, the at least one processing element may be configured to provide the at least one ticket option to the user.

According to other embodiments, the present disclosure includes methods for operating an online marketplace. Various embodiments of such a method may include receiving at least one ticket request to at least one event from a user. The method may also include identifying at least one ticket option including one or more potential tickets for the at least one event based on the at least one ticket request and user data. Further, the method may include providing the at least one ticket option to the user.

In another embodiment, a method may include identifying a user of an online marketplace. In addition, the method may include accessing data associated with the user including at least one of historical data, location data, and user defined data. The method may further include providing the user with at least one ticket option including at least one potential ticket for at least one event based on the data associated with the user.

Yet other embodiments of the present disclosure comprise computer-readable media storage storing instructions that when executed by a processor cause the processor to perform instructions in accordance with one or more embodiments described herein.

Other aspects, as well as features and advantages of various aspects, will become apparent to those of skill in the art though consideration of the ensuing description, the accompanying drawings and the appended claims.

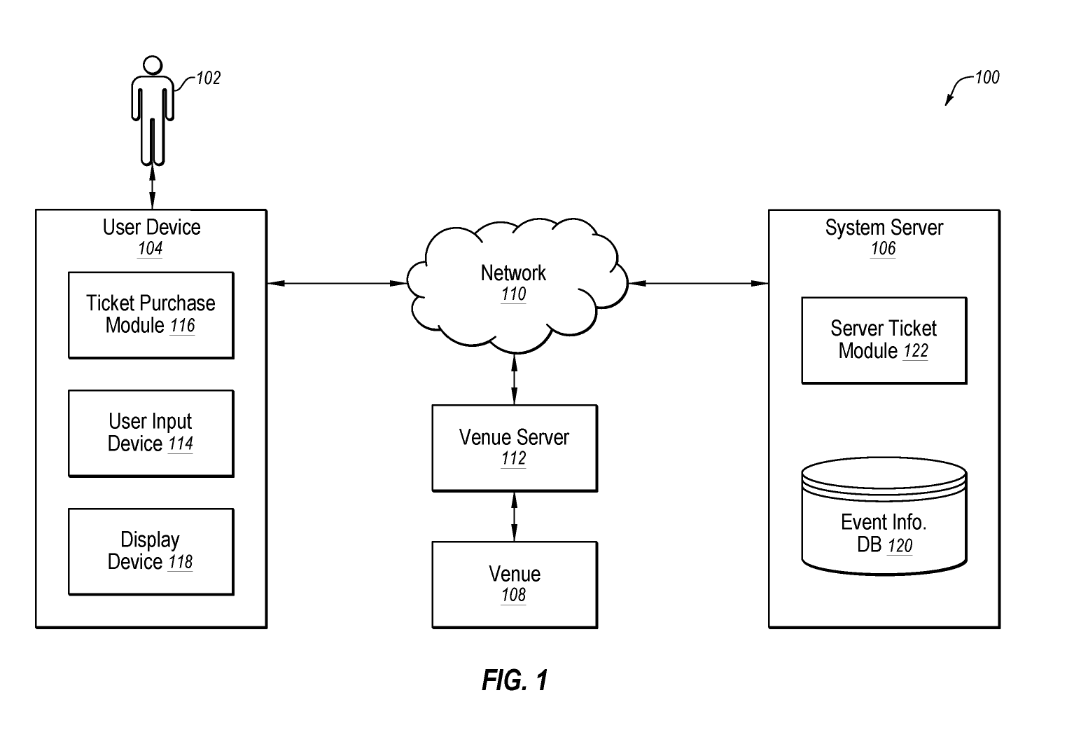

FIG. 1 illustrates an example system 100 in which an online ticket marketplace (hereinafter, “marketplace”) may be implemented. In system 100, a user 102 may interact with a user device 104 to search for and/or obtain tickets, which may be listed on a site that is hosted or controlled by a system server 106. The tickets may be for an event that occurs at a venue 108. System 100 may also include a network 110 and a venue server 112. System server 106, user device 104, and venue server 112 (collectively, environment components) may communicate data via network 110. For example, one or more of the environment components may communicate data related to ticket transactions such as user input and event information. Each of the environment components is briefly described in the following paragraphs.

Network 110 may include a wired network, a wireless network, or any combination thereof. Network 110 may include any suitable configuration or configurations including a star configuration, token ring configuration, or other configurations. Network 110 may include a local area network (LAN), a wide area network (WAN) (e.g., the Internet), and/or other interconnected data paths across which multiple devices may communicate. In some embodiments, network 110 may include a peer-to-peer network. Network 110 may also be coupled to or include portions of a telecommunications network that may enable communication of data in a variety of different communication protocols. In some embodiments, network 110 includes BLUETOOTH® communication networks and/or cellular communication networks for sending and receiving data including via short messaging service (SMS), multimedia messaging service (MMS), hypertext transfer protocol (HTTP), direct data connection, wireless application protocol (WAP), e-mail, and the like.

User 102 may include an individual or an entity that may interface with user device 104 to participate in a ticketing search or a ticketing transaction. For example, user 102 may include a person who wants to purchase a ticket for a particular event to take place at venue 108.

User device 104 may include a computing device that may include a processor, memory, and network communication capabilities. User device 104 may be configured for communication with one or more other environment components via network 110. Further, user device 104 may include a location determination device, such as a GPS device. Some examples of user device 104 include a laptop computer, a desktop computer, a tablet computer, a mobile telephone, a smartphone, a personal digital assistant (“PDA”), a mobile e-mail device, a portable game player, a portable music player, smart wearable technology, or any other applicable electronic device capable of accessing network 110.

User device 104 may include a user input device 114, a ticket purchase module 116, and a display device 118. User input device 114 may include hardware configured to notify user 102 of a communication, and/or present a communication to user 102. In some embodiments, user input device 114 may include a speaker, a microphone, a display device (e.g., display device 118), a joystick, a direction pad (D-pad), a trigger input, a motion sensor, an eye tracker, a trackpad, a thermal input capturing device, a keyboard, a touch screen, and/or other hardware devices. In these and other embodiments, user input device 114 may also be configured to receive input from user 102. The user input may include user defined data, such as, the user's favorite sports teams, favorite performers, favorite event types (e.g., concerts, sporting events, shows, etc.), and/or preferences regarding tickets in a venue (e.g., venue 108). More specifically, for example, the user input may include user defined preferred seating areas within a venue, such as a preferred sections, row, seats, etc. Further, the user data may include data related to the user's interest in ticket packages and/or the user's interest in specific offers (e.g., food, parking, back stage pass, etc.) of ticket packages.

Display device 118 may include a substantially planar surface on which data may be displayed to user 102. In addition, in some embodiments, at least a portion of the user input may be received by display device 118. Some examples of display device 118 may include a light emitting diode (LED) display, liquid crystal displays (LCD) thin film transistor (TFT) LCD, in-place switching (IPS) LCD, resistive touchscreen LCD, capacitive touchscreen LCD, organic LED (OLED), active-matrix OLED, etc.

Ticket purchase module 116 may be configured to receive (e.g., via input device 114), and possible process, user input. As noted above, the user input may include data related to user 102, such as, user's 102 favorite sports teams, favorite performers, event interests (e.g., concerts, sporting events, shows, etc.), preferences regarding tickets in a venue (e.g., venue 108) (e.g., location and/or price), and/or preferences in ticket packages. In addition, ticket purchase module 116 may be configured to include, and possible receive (e.g., from system server 106), historical data (e.g., data related to user's 102 ticket purchasing history and/or a user's ticket browsing history), location data (e.g., a location of the user), user preferences (e.g., related to tickets and/or events), and/or other data related to the user that may be used in identifying one or more potential event tickets for user 102.

Ticket purchase module 116 may be implemented using hardware including a processor, a microprocessor (e.g., to perform or control performance of one or more operations), a field-programmable gate array (FPGA), or an application-specific integrated circuit (ASIC). In some other instances, the ticket purchase module 116 may be implemented using a combination of hardware and software. As will be appreciated, implementation in software may include rapid activation and deactivation of one or more transistors or transistor elements such as may be included in hardware of a computing system (e.g., the user device 104). Additionally, software defined instructions may operate on information within transistor elements. Implementation of software instructions may at least temporarily reconfigure electronic pathways and transform computing hardware.

Venue 108 may include any forum in which an event may take place or are performed. Some examples of venue 108 may include a stadium, an arena, a theatre, a parking lot, a fairground, and the like. The event may include any type of happening in which tickets are used for entry. Some examples of the event are sporting events, concerts, plays, movies, festivals, and the like. Venue 108 may be associated with venue server 112.

Venue server 112 may include a hardware server that includes a processor, memory, and network communication capabilities. In the illustrated implementation, venue server 112 may be configured to communicate via network 110 with the other environment components. Venue server 112 may track event information that pertains to a particular event that is to occur or is occurring at venue 108. For example, the event information may include ticket prices or ticket availability.

System server 106 may include a hardware server that includes a processor, memory, and network communication capabilities. In the illustrated implementation, system server 106 is configured to communicate via network 110 with the other environment components. System server 106 may include an event information database 120 and a server ticket module 122. Event information database 120 may store event information pertaining to one or more particular events occurring at venue 108. For example, the event information may include one or more ticket prices for one or more seating sections or for one or more seats of venue 108, ticket availability for one or more seating sections or for one or more of the seats of venue 108, ticket packages for events, and the like.

The event information may originate at system server 106. For instance, the event information may be generated through sales of tickets to users. The event information may also originate at venue server 112. Venue server 112 may track ticket sales via system server 106 and/or via other systems. Venue server 112 may communicate the event information representative of the ticket sales to system server 106. Accordingly, event information database 120 may include updated event information. Although not explicitly shown in FIG. 1, the event information in event information database 120 may also originate at other sources. While event information database 120 is depicted in system server 106, in other embodiments, event information database 120 may be located remotely and accessed by system server 106.

Server ticket module 122 may be configured to identify one or more users (e.g., user 102) of system 100. Further, server ticket module 122 may be configured to track user activity, and generate and store historical data for the one or more users. Server ticket module 122 may further be configured to receive and store user defined data and/or location data from the one or users. Server ticket module 122 may be implemented using hardware including a processor, a microprocessor (e.g., to perform or control performance of one or more operations), an FPGA, or an ASIC. In some other instances, server ticket module 122 may be implemented using a combination of hardware and software.

Server ticket module 122, ticket purchase module 116, or a combination thereof may be configured to identify one or more ticket options including one or more recommended tickets for a user based on user data, as described more fully below.

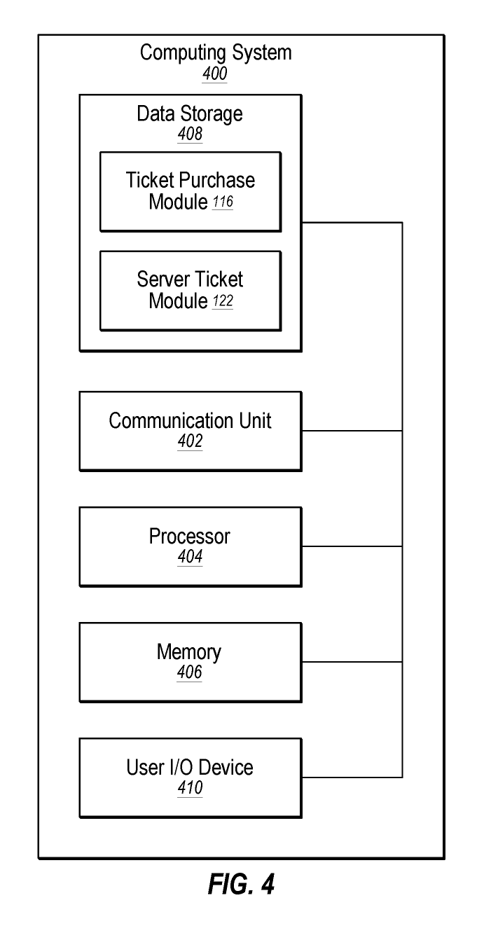

In system 100, memory in one or more of the environment components may be similar to memory 406 described with reference to FIG. 4, processors in one or more of the environment components may be similar to a processor 404 described with reference to FIG. 4, and network communication capabilities of one or more of the environment components may be provided by a communication unit 402 described with reference to FIG. 4.

Modifications, additions, or omissions may be made to system 100 without departing from the scope of the present disclosure. Specifically, embodiments depicted in FIG. 1 include one or more user devices 104, one or more users 102, one or more venue servers 112, one or more venues 108, one or more system servers 106, or any combination thereof.

Moreover, the separation of various components in the embodiments described herein is not meant to indicate that the separation occurs in all embodiments. It may be understood with the benefit of this disclosure that the described components may be integrated together in a single component or separated into multiple components. For example, in some embodiments the user input device 114 and the display device 118 may be a single device.

As noted above, various embodiments of the present disclosure relate to online ticket marketplaces and, more specifically to identifying recommended event tickets (i.e., that may be the “best match”) for a user. According to some embodiments, one or more factors may be considered in identifying potential tickets (also referred to herein as “recommended tickets”) for a user. For example, user data, such as historical data (e.g., a user's ticket purchasing history and/or a user's ticket browsing history), location data (e.g., a location of the user), user preferences, and/or other data related to the user may be used in identifying one or more tickets for the user. Ticket data (e.g., price, % discounted, value, etc.) may also be used in identifying one or more potential tickets for the user.

More specifically, as an example, if user 102 has previously purchased one or more tickets in a specific area (e.g., section, row, seat) of a venue, tickets in the same area (e.g., section, row, seat) may be identified as potential (e.g., preferred) tickets for user 102. As an example, tickets in an area that is the same as an area in which user 102 has previously purchased tickets may be given priority (e.g., in a prioritized list of recommended tickets) over tickets in another area. As a more specific example, tickets in a section and row that is the same as a section and row in which user 102 has previously purchased tickets may be given priority over tickets in the same section but different row.

Further, historical data (e.g., the user's search and/or browsing history in an online marketplace) may be used to identify potential tickets for user 102. For example, if user 102 has searched for and/or viewed tickets in a specific area of a venue, tickets in that area may be identified as potential tickets for user 102. In another embodiment, user 102 may identify (e.g. via a user device, such as user device 104) preferred areas (e.g., zones, sections, row, seats) within a venue. In this embodiment, the user defined data may be used in identifying tickets to be recommended for user 102.

In addition, location data (e.g., a location (e.g., state, city, zip, etc.) of user 102) may be used to identify potential tickets. A location of user 102 may be determined by any known and suitable method. For example, in one specific embodiment, user device 104 may include a GPS device. In another embodiment, an IP zip code of user device 104 may be used to determine a location of user 102.

In one embodiment, ticket options, which may include a list of recommended tickets, may be provided to the user 102. Further, according to one embodiment, the list may be prioritized (e.g., with the tickets having the best match (i.e., according to the user data) being at the top of the list of ticket options).

According to another embodiment, users of an online marketplace may be grouped into two or more groups. For example, users that are price sensitive (e.g., users that are looking for the best value or biggest discount) and/or are merely interested in gaining access to an event may be assigned to a group (referred to herein as a “best value group”). Other users, which may not be assigned to the best value group, may be assigned to another group (referred to herein as a “best match group”). Users assigned to the best value group may be provided with ticket recommendations based on ticket data (e.g., based on the lowest price and/or highest discounted tickets). Users not assigned to the best value group (e.g., users assigned to the best match group), may be provided with ticket recommendations based on one or more factors (e.g., user data), as described herein.

In yet another embodiment, ticket packages, which may include one or more tickets to an event and, for example, free or discounted parking, free or discounted food (e.g., all you can eat), back-stage access, tail-gate access, access to a performer (e.g. meet and greet), access to a party (e.g., VIP party) may be assigned a monetary and/or an emotional value, and may be given priority (e.g., as promoted and/or sponsored ticket packages) in a list of ticket options provided to a user

According to another embodiment, a seat quality score may be assigned to one or more seats (e.g., all seats) at a venue based on historical purchase data over a time period (e.g., a year or more). The seat quality score may affect the ranking of tickets in a list of recommended tickets. For example, seats that have low quality score may not necessarily make it to the top of the “best match” sort list as “priced low to high” sort method.

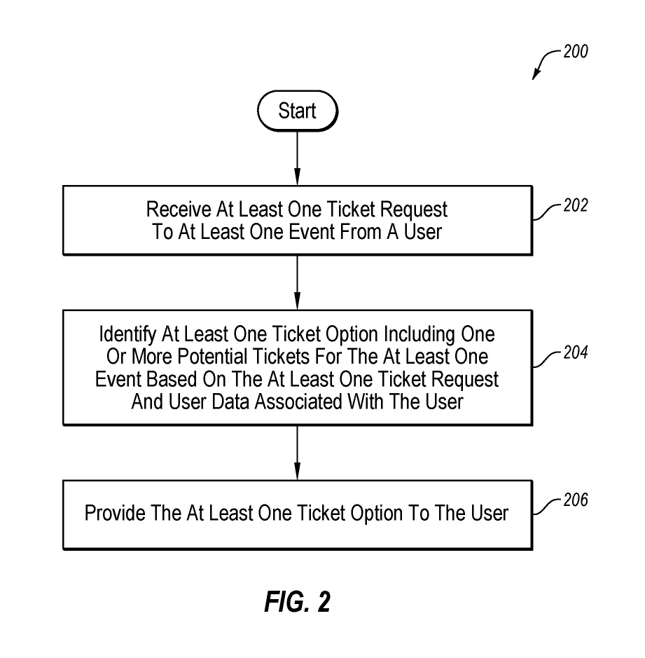

FIG. 2 is a flowchart illustrating an example method 200. Method 200 may be arranged in accordance with at least one embodiment described herein. Method 200 may be implemented, in some embodiments, by a system, such as system 100 and/or system 400 of FIGS. 1 and 4, respectively. Although illustrated as discrete blocks, various blocks of method 200 may be divided into additional blocks, combined into fewer blocks, or eliminated, depending on the desired implementation.

At block 202, at least one ticket request to at least one event from a user may be received, and method 200 may proceed to block 204. For example, the user, using an online marketplace system (e.g., system 100 and/or system 400), may search for tickets to an event, such as a sporting event or concert.

At block 204, at least one ticket option including one or more potential tickets for the at least one event may be identified based on the at least one ticket request and user data, and method may proceed to block 206. For example, historical data for the user (e.g., purchasing or browsing history of the user) may be used to identify at least one ticket option for the user.

At block 206, the at least one ticket option may be provided to the user. For example, the at least one ticket option, which may include a prioritized list of recommended tickets, may be conveyed from a remote server (e.g., system server 106; see FIG. 1) to a user device (user device 104; see FIG. 1) via a network (e.g., network 110; see FIG. 1) and displayed to the user (e.g., user 102; see FIG. 1) via a display device (e.g., display device 118 of user device 104).

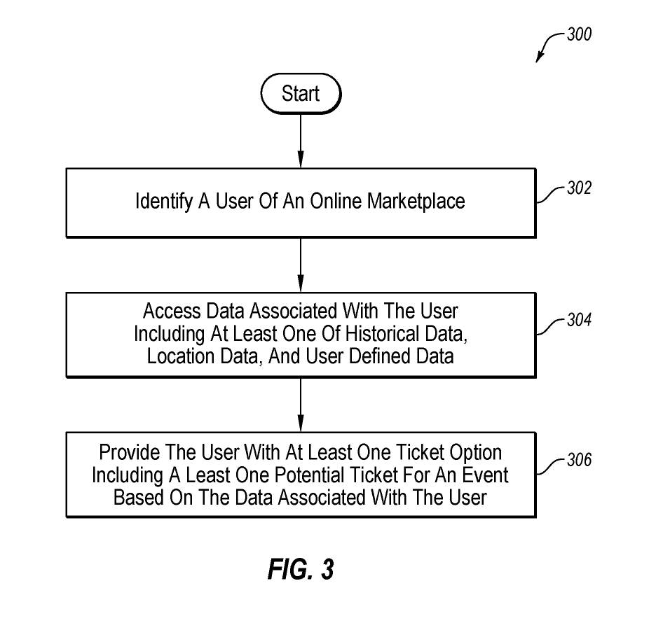

FIG. 3 is a flowchart illustrating another method 300, in accordance with one or more embodiments. Method 300 may be implemented, in some embodiments, by a system, such as system 100 and/or system 400 of FIGS. 1 and 4, respectively. Although illustrated as discrete blocks, various blocks of method 300 may be divided into additional blocks, combined into fewer blocks, or eliminated, depending on the desired implementation.

At block 302, a user of an online marketplace may be identified, and method 300 may proceed to block 304. For example, a server (e.g., system server 106; see FIG. 1) may identify a user (e.g., user 102; see FIG. 1) via communication with a user device (e.g., user device 104; see FIG. 1).

At block 304, data associated with the user including at least one of historical data, location data, and user defined data may be accessed, and method 300 may proceed to block 306. For example, historical data (e.g., ticket searching history and/or ticker browsing history of the user), location data (e.g., a location of the user), and/or user defined data (e.g., user preferences and/or user interests) may be accessed by a server (e.g., system server 106; see FIG. 1).

At block 306, at least one ticket option including at least one potential ticket for an event based on the data associated with the user may be provided to the user. For example, the at least one ticket option, which may include a prioritized list of recommended tickets, may be conveyed from a remote server (e.g., system server 106; see FIG. 1) to a user device (user device 104; see FIG. 1) via a network (e.g., network 110; see FIG. 1) and displayed to the user (e.g., user 102; see FIG. 1) via a display device (e.g., display device 118 of user device 104).

FIG. 4 illustrates an example computing system 400. Computing system 400 may be configured for marketplace transactions, arranged in accordance with at least one embodiment described herein. Computing system 400 may include a communication unit 402, one or more processors 404, a memory 406, user input/output (I/O) device 410, and a data storage 408, which may include ticket purchase module 116 and server ticket module 122. Some examples of computing system 400 may include user device 104, system server 106, and venue server 112 discussed elsewhere in this disclosure.

Processor 404 may include any suitable special-purpose or general-purpose computer, computing entity, or processing device including various computer hardware or software modules and may be configured to execute instructions stored on any applicable computer-readable storage media. For example, processor 404 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 4, it is understood that processor 404 may include any number of processors configured to perform individually or collectively any number of operations described herein. Additionally, one or more of the processors may be present on one or more different electronic devices. In some embodiments, processor 404 may interpret and/or execute program instructions and/or process data stored in memory 406, data storage 408, or memory 406 and data storage 408. In some embodiments, processor 404 may fetch program instructions from data storage 408 and load the program instructions in memory 406. After the program instructions are loaded into memory 406, processor 404 may execute the program instructions.

Memory 406 and data storage 408 may include computer-readable storage media for carrying or having computer-executable instructions or data structures stored thereon. Such computer-readable storage media may include any available media that may be accessed by a general-purpose or special-purpose computer, such as the processor 404. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause processor 404 to perform a certain operation or group of operations.

Communication unit 402 may include hardware configured to receive and send communications. In some embodiments, communication unit 402 may include an antenna, a wired port, and/or modulation/demodulation hardware, among other communication hardware devices. In particular, communication unit 402 may be configured to receive a communication (e.g., from a remote device) and present the communication to processor 404 for classifying or to send a communication from processor 404 to another device or network.

I/O device 410 may include hardware configured to notify a user of computing system 400 of a communication, present a communication to a user, or to notify a user of a communication and present the communication to the user. In some embodiments, I/O device 410 may include a speaker, a microphone, a display, a keyboard, and/or a touch screen, among other hardware devices. In these and other embodiments, I/O device 410 may also be configured to receive input from a user of computing system 400.

In view of this disclosure, it will be appreciated that modifications, additions, or omissions may be made to system 400 without departing from the scope of the present disclosure. For example, in some embodiments, system 400 may not include I/O device 410. In these and other embodiments, system 400 may be a server or other computing device or system that monitors for occurrence of monitored events using communication unit 402. In some embodiments, the different components of system 400 may be physically separate may be communicatively coupled via any suitable mechanism. For example, data storage 408 may be part of a storage device that is separate from a server, which includes processor 404, memory 406, and the communication interface, that is communicatively coupled to the storage device.

As indicated above, the embodiments described herein may include the use of a special purpose or general purpose computer (e.g., processor 404 of FIG. 4) including various computer hardware or software modules, as discussed in greater detail below. Further, as indicated above, embodiments described herein may be implemented using computer-readable media (e.g., memory 406 of FIG. 4) for having computer-executable instructions or data structures stored thereon.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A system, comprising:
at least one processing element configured to:
identify a user of an online marketplace;
determine at least one ticket option including at least one potential ticket for at least one event based on user data associated with the user; and
provide the at least one ticket option to the user.

2. The system of claim 1, where the user data comprises at least one of user defined data, historical data for the user, and location data for the user.

3. The system of claim 2, wherein the historical data comprises at least one of purchasing history data and browsing history data for the user.

4. The system of claim 2, wherein the user defined data comprises seating preferences for the user.

5. The system of claim 1, wherein the at least one processing element is further configured to group the user into a group of a plurality of groups based on the user data.

6. The system of claim 5, wherein the at least one processing element is further configured to group the user into a best match group of the plurality of groups.

7. The system of claim 1, wherein the at least one processing element is further configured to identify one or more ticket packages to be included in the at least one ticket option.

8. A method, comprising:
receiving at least one ticket request to at least one event from a user;
identifying at least one ticket option including one or more potential tickets for the event based on the at least one ticket request and user data; and
providing the at least one ticket option to the user.

9. The method of claim 8, wherein providing comprises providing the at least one ticket option including a prioritized list of recommended tickets to the user.

10. The method of claim 8, further comprising accessing the user data including at least one of user defined data, historical data for the user, and location data for the user.

11. The method of claim 8, further comprising identifying one or more ticket packages to be included in the at least one ticket option.

12. The method of claim 8, wherein identifying comprises identifying the at least one ticket option including one or more potential tickets for the event based on the at least one ticket request and at least one of historical data for the user and location data for the user.

13. The method of claim 12, wherein identifying the at least one ticket option for the event comprises identifying the at least one ticket option for the event based on the historical data including at least one of purchasing history data and browsing history data for the user.

14. The method of claim 12, wherein identifying the at least one ticket option for the event based on the historical data comprises identifying the at least one ticket option for the event based on one or more tickets previously purchased by the user.

15. The method of claim 8, wherein identifying the at least one ticket option for the event comprises identifying the at least one ticket option for the event based on a location of the user.

16. One or more non-transitory computer-readable media storing one or more programs that are configured, when executed, to cause one or more machines to execute the method as recited in claim 8.

17. A method, comprising:
identifying a user of an online marketplace;
accessing data associated with the user including at least one of historical data, location data, and user defined data; and
providing the user with at least one ticket option including at least one potential ticket for at least one event based on the data associated with the user.

18. The method of claim 17, wherein identifying a user comprises identifying the user as being grouped in a best match group.

19. The method of claim 17, wherein accessing data comprises accessing historical data including at least one of purchasing history for the user and browsing history for the user.

20. One or more non-transitory computer-readable media storing one or more programs that are configured, when executed, to cause one or more machines to execute the method as recited in claim 17.
